(19) United States
(12) Patent Application Publication
(10) Pub. No.: US 2022/0245722 A1
(43) Pub. Date: Aug. 4, 2022

(54) ELECTRONIC TRADING SYSTEM, TRADING MANAGEMENT SERVER, ELECTRONIC TRADING METHOD, AND PROGRAM

(71) Applicant: NEC Corporation, Minato-ku, Tokyo (JP)

(72) Inventor: Batnyam ENKHTAIVAN, Tokyo (JP)

(73) Assignee: NEC Corporation, Minato-ku, Tokyo (JP)

(21) Appl. No.: 17/618,706

(22) PCT Filed: Jun. 25, 2019
(86) PCT No.: PCT/JP2019/025057

§ 371 Date: Dec. 13, 2021

(51) Int. Cl. G06Q 40/04; G06Q 50/06; H04L 9/30

(52) U.S. Cl. CPC G06Q 40/04; H04L 9/3073; G06Q 50/06

(57) ABSTRACT

In order to provide an electronic trading system contributing to providing fair trading, an electronic trading system includes a plurality of management servers, a participant terminal, and a trading management server. The plurality of management servers provide a first electronic bulletin board. The participant terminal writes bid data in the first electronic bulletin board. The trading management server acquires the written bid data, and uses the acquired bid data to execute trading through Zaraba method. The trading management server generates a public key and a private key. The participant terminal uses the public key generated by the trading management server to encrypt the bid data. The trading management server uses the private key to decrypt the encrypted bid data.

### BACKGROUND

### Technical Field

The present invention relates to an electronic trading system, a trading management server, and an electronic trading method, and a program.

### Background Art

In recent years, various services have been provided over a network with the development of communication technologies and information processing technologies. For example, NPL 1 discloses a system for buying and selling electricity over a network.

PTL 1 discloses a technique for an electricity consumer to communicate with a demand response system under anonymity. PTL 2 describes that an electronic bidding system and an electronic bidding method are provided in which a list of public keys corresponding to bid prices does not need to be disclosed to a bidder and proof of price secrecy is possible. PTL 3 describes that privacy of a bidder is protected, bid-rigging is prevented, and a profit of a requester is protected.

### CITATION LIST

### Patent Literature

[PTL 1] JP 2017-059872 A
[PTL 2] WO 2007/063876
[PTL 3] JP 2001-101316 A

### Non Patent Literature

[NPL 1] Kenji Tanaka, et al., “A Proposal on an Electricity Interchange Trading Platform Using Blockchain”, Jan. 23, 2018, SCIS 2018

### SUMMARY

### Technical Problem

As described above, NPL 1 discloses a technique using the blockchain for electricity trading. According to NPL 1, each individual user can estimate excess or shortage of electric power based on an electricity consumption amount or power generation amount of the user, and order and buy/sell electricity on a blockchain to achieve electricity trading.

However, in NPL 1, a bit of a participant is registered in a plain text so that another participant can see the bid. Thus, the participant can grasp an ordering situation, trading price, and trading volume of another person. When the ordering situation of another person can be grasped, a fair trading may be impaired. For example, a fraud may be missed in which despite no will to conduct buying or selling, a large amount of buying bids is conducted to make it appear as if an electricity demand is vigorous and attain electricity selling at an advantageous price.

Note that the techniques disclosed in PTLs 1 to 3, the above problems cannot be solved. For example, the technique disclosed in PTL 1, which is for achieving an anonymous communication, cannot be adopted to prevent a fraud. The techniques disclosed in PTL 2 and 3, which are techniques related to a sealed bid, cannot be applied to an electricity trading system as disclosed in NPL 1.

The present invention has an example object to provide an electronic trading system, a trading management server, an electronic trading method, and a program contributing to providing a fair trading.

### Solution to Problem

According to a first example aspect of the present invention, there is provided an electronic trading system including: a plurality of management servers configured to provide a first electronic bulletin board; a participant terminal configured to write bid data in the first electronic bulletin board; and a trading management server configured to acquire the written bid data, and use the acquired bid data to execute trading through Zaraba method. The trading management server is configured to generate a public key and a private key, the participant terminal is configured to use the public key generated by the trading management server to encrypt the bid data, and the trading management server is configured to use the private key to decrypt the encrypted bid data.

According to a second example aspect of the present invention, there is provided a trading management server. The trading management server is configured to generate a public key and a private key. The trading management server is connected to a plurality of management servers providing an electronic bulletin board, and a participant terminal using the public key to write bid data encrypted in the electronic bulletin board. The trading management server is configured to acquire the written bid data to decrypt the encrypted bid data with the private key, and use the bid data to execute trading through Zaraba method.

According to a third example aspect of the present invention, there is provided an electronic trading method, in an electronic trading system including a plurality of management servers configured to provide an electronic bulletin board, a participant terminal configured to write bid data in the electronic bulletin board, and a trading management server configured to acquire the written bid data, and use the acquired bid data to execute trading through Zaraba method. The electronic trading method includes generating a public key and a private key, using the public key generated by the trading management server to encrypt the bid data, and using the private key to decrypt the encrypted bid data.

According to a fourth example aspect of the present invention, there is provided a program causing a computer, the computer being mounted on a trading management server, the trading management server generating a public key and a private key, and being connected to a plurality of management servers providing an electronic bulletin board and to a participant terminal using the public key to write bid data encrypted in the electronic bulletin board, to execute the processes of: acquiring the written bid data, decrypting the encrypted bid data with the private key, and using the bid data to execute trading through Zaraba method.

### Advantageous Effects of Invention

According to the above example aspects of the present invention, there are provided an electronic trading system, a trading management server, an electronic trading method, and a program contributing to providing a fair trading. Note that, according to the present invention, instead of or together with the above effects, other effects may be exerted.

### BRIEF DESCRIPTION OF THE DRAWINGS

FIG. 1 is a diagram for describing an overview of an example embodiment;

FIG. 2 is a diagram illustrating an example of a configuration of an electronic trading system according to a first example embodiment;

FIG. 3 is a sequence diagram illustrating an example of a schematic operation of the electronic trading system according to the first example embodiment;

FIG. 4 is a diagram illustrating an example of bid data;

FIG. 5 is a diagram illustrating an example of contract data;

FIG. 6 is a diagram illustrating an example of information written in a general-purpose data bulletin board;

FIG. 7 is a block diagram illustrating an example of a processing configuration of a trading management server according to the first example embodiment;

FIG. 8 is a diagram illustrating an example of a bid management table.

FIG. 9 is a flowchart illustrating an example of an operation of a trading executing section;

FIG. 10 is a flowchart illustrating an example of the operation of the trading conduct section;

FIG. 11 is a block diagram illustrating an example of a processing configuration of a participant terminal according to the first example embodiment;

FIG. 12 is a block diagram illustrating an example of a processing configuration of a management server according to the first example embodiment;

FIG. 13 is a sequence diagram illustrating an example of an operation of the electronic trading system according to the first example embodiment;

FIG. 14 is a diagram illustrating an example of a configuration of an electronic trading system according to a second example embodiment;

FIG. 15 is a diagram for describing a trading management server and a control apparatus according to the second example embodiment.

FIG. 16 is a diagram illustrating an example of a processing configuration of the trading management server according to the second example embodiment;

FIG. 17 is a sequence diagram illustrating an example of an operation of the trading management server according to the second example embodiment;

FIG. 18 is a sequence diagram illustrating an example of an operation of the electronic trading system according to the second example embodiment;

FIG. 19 is a diagram illustrating an example of a hardware structure of the trading management server; and

FIG. 20 is a diagram for describing a trading executing apparatus and a trading verification apparatus.

### DESCRIPTION OF THE EXAMPLE EMBODIMENTS

First, an overview of an example embodiment is described. Note that reference signs in drawing used in the overview are added to elements for the purpose of convenience merely as examples to facilitate understanding, and descriptions in the overview are not intended for any limitation. Note that, in the Specification and drawings, elements to which similar descriptions are applicable are denoted by the same reference signs, and overlapping descriptions may hence be omitted.

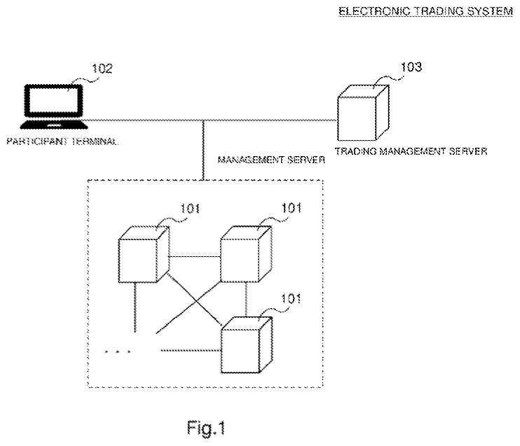

An electronic trading system according to an example embodiment includes a plurality of management servers 101, a participant terminal 102, and a trading management server 103 (see FIG. 1). The plurality of management servers 101 provide a first electronic bulletin board. The participant terminal 102 writes bid data in the first electronic bulletin board. The trading management server 103 acquires the written bid data, and uses the acquired bid data to execute trading through Zaraba method. The trading management server 103 generates a public key and a private key. The participant terminal 102 uses the public key generated by the trading management server 103 to encrypt the bid data. The trading management server 103 uses the private key to decrypt the encrypted bid data.

In the electronic trading system described above, the participant terminal 102 uses the public key of the trading management server 103 to encrypt the bid data and registers the encrypted bid data with the electronic bulletin board. The encrypted bid data can be decrypted by the trading management server 103 having the private key, and another participant cannot know contents of the bid data. As a result, confidentiality of information related to the bid is maintained, and the electronic trading system can provide a fair trading.

Hereinafter, specific example embodiments are described in more detail with reference to the drawings.

### First Example Embodiment

A first example embodiment is described in more detail using the drawings.

[Schematic System Configuration]

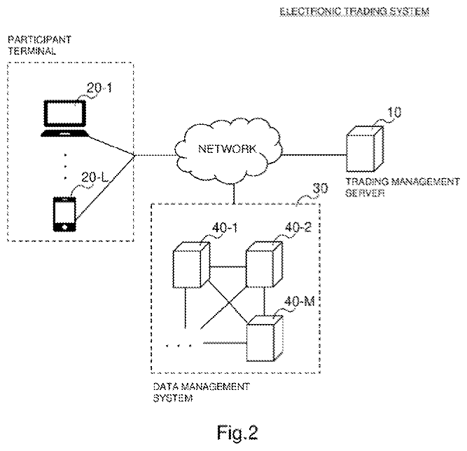

FIG. 2 is a diagram illustrating an example of a configuration of an electronic trading system according to the first example embodiment; With reference to FIG. 2, the electronic trading system is configured to include a trading management server 10, a plurality of participant terminals 20-1 to 20-L (L represents a positive integer, which applies to the following), and a data management system 30.

The trading management server 10, the participant terminals 20-1 to 20-L, and the data management system 30 are connected to each other via a network such as the Internet.

Although a subject of trading for the electronic trading system is not specifically limited, the disclosure of the present application gives a description of mainly “electricity (electric power)” as a subject of trading. However, the electronic trading system in the disclosure of the present application is applicable also to trading of, for example of, financial instruments such as stock.

The trading management server 10 is an apparatus for mediating orders between a buyer and a seller for electricity.

The participant terminals 20-1 to 20-L are terminals used by participants in electricity trading. For example, information processing apparatuses such as a personal computer and a smartphone correspond to the participant terminals 20 described above. Note that in the following description, the participant terminals 20-1 to 20-L, in a case of no special reason for being distinguished, are expressed merely as the “participant terminal 20”.

In a case that a user of the participant terminal 20 desires electricity buying, a terminal used by the user is expressed as a “buyer terminal”. Similarly, in a case that a user of the participant terminal 20 desires electricity selling, a terminal used by the user is expressed as a “seller terminal”.

The data management system 30 is a system managed by an institution or the like independent from a managing entity of the trading management server 10 and the participant in the electricity trading (bidder; seller and buyer). The data management system 30 is a system for providing an electronic bulletin board capable of additional writing and reading to the outside (third party). To be more specific, the data management system 30 provides an electronic bulletin board which any entity can additionally write information in and can read the written information from, and in which information once written is not deleted or falsified. The data management system 30 provides the electronic bulletin board having the characteristics described above through technology of a so-called blockchain.

In the electronic trading system illustrated in FIG. 2, information required for the electricity trading (hereinafter, referred to as electricity trading data) is transferred or received via the electronic bulletin board that is implemented by the blockchain. Note that as described above, the data management system 30 is the system providing the electronic bulletin board to any entity (any entity including the participant related to the electricity trading), and thus, the electronic bulletin board also contains data unrelated to the electricity trading data described above.

In the description below, the electronic bulletin board provided by the data management system 30 is expressed as a “general-purpose data bulletin board”. A ledger as a base of the general-purpose data bulletin board is expressed as a “general-purpose data management ledger”.

The data management system 30 includes a plurality of management servers 40-1 to 40-M (M represents a positive integer, which applies to the following). Similar to the participant terminal 20, the management servers 40-1 to 40-M, in a case of no special reason for being distinguished, are expressed merely as the “management server 40”.

The plurality of management servers 40 constituting the data management system 30 are directly connected to each other as illustrated in FIG. 2. In other words, the data management system 30 is configured to include the plurality of management servers 40 which are Peer to Peer (P2P)-connected.

In the data management system 30, each of the plurality of management servers 40 that are P2P-connected has a data management ledger for managing data received from outside thereof (for example, the electricity trading data). The data management system 30 manages the data management ledger distributed to and shared by the plurality of management servers 40.

The management server 40 constituting the data management system 30, every time acquiring a request for writing electricity trading data in the general-purpose data bulletin board from the trading management server 10 or the participant terminal 20 (data record request), additionally records the electricity trading data in the general-purpose data management ledger. Each management server 40 generates data proving legitimacy of the data additionally recorded in the general-purpose data management ledger. Specifically, the management server 40 uses an electronic signature (digital signature) of each management server 40 as the data proving the legitimacy of the above-described additionally recorded data.

After generating the electronic signature, the management server 40 appends the electronic signature to the additionally recorded data in the general-purpose data management ledger, and delivers the data to other management servers 40. Other management servers 40, when receiving the additionally recorded data, verify the legitimacy of the received data, and then, update the general-purpose data management ledger of themselves.

### [Schematic System Operation]

Next, a schematic operation of the electronic trading system according to the first example embodiment is described with reference to the drawings.

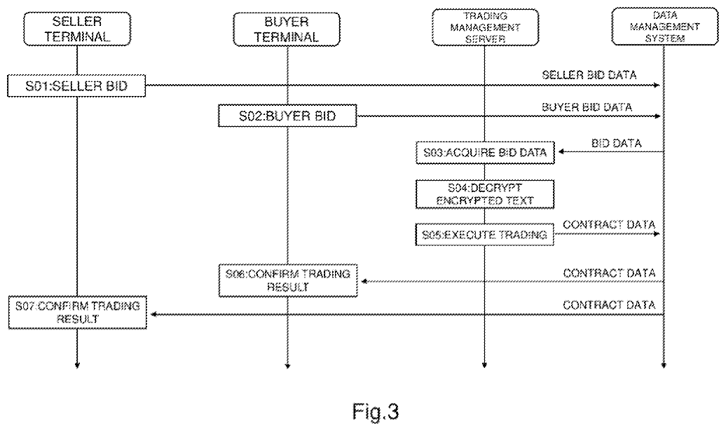

FIG. 3 is a sequence diagram illustrating an example of the schematic operation of the electronic trading system according to the first example embodiment.

The participant desiring the electricity selling writes, in the general-purpose data bulletin board, “seller bid data” including a type of buying or selling (sell order), an identifier for identifying the participant (participant IDentifier (ID)), a desired selling amount of electricity (quantity), and a desired selling price (price) (seller bid, step S01).

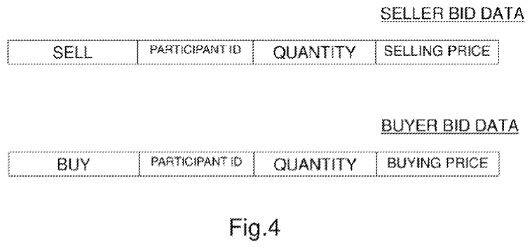

At this time, the seller terminal encrypts the seller bid data with a public key of the trading management server 10 and transmits the encrypted seller bid data to the data management system 30. For example, data as illustrated in an upper row in FIG. 4 is encrypted and written in the general-purpose data bulletin board.

Similarly, the participant desiring the electricity buying writes, in the general-purpose data bulletin board, “buyer bid data” including the type of buying or selling (buy order), the participant ID for identifying the participant, a desired buying amount of electricity, and a desired buying price (buyer bid, step S02).

The buyer terminal encrypts the buyer bid data with the public key of the trading management server 10 and transmits the encrypted buyer bid data to the data management system 30. For example, data as illustrated in a lower row in FIG. 4 is encrypted and written in the general-purpose data bulletin board.

The participant terminal 20 may not encrypt all of four items (type of buying or selling, participant ID, quantity, and price) illustrated in FIG. 4, but may encrypt only the quantity. This is because if at least the quantity is encrypted, security of the trading can be ensured. In this way, the participant terminal 20 according to the first example embodiment writes the bid data including the encrypted price in the general-purpose data bulletin board.

Note that in the following description, the seller bid data and the buyer bid data, in a case of not necessarily being distinguished, are expressed merely as the “bid data”.

The trading management server 10 periodically accesses the general-purpose data bulletin board to acquire the bid data (step S03).

Because the acquired bid data is encrypted, the trading management server 10 decrypts an encrypted text of the acquired bid data with the private key of the trading management server 10 (step S04).

The trading management server 10 executes trading using the acquired bid data at a predetermined timing or the like (step S05). Details of the trading processing by the trading management server 10 are described later.

The trading management server 10 writes a trading result in the general-purpose data bulletin board.

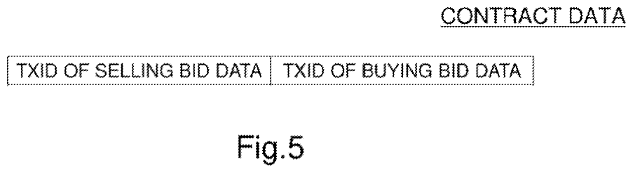

Note that once the bid data is written in the general-purpose data bulletin board, a transaction ID for identifying the bid data (hereinafter, referred to as a TXID) is given. The trading management server 10 uses the TXID to write the trading result in the general-purpose data bulletin board. Specifically, in a case that a selling bid and a buying bid are concluded (contracted), the trading management server 10 writes data including the TXID of the contracted bid data as “contract data” in the general-purpose data bulletin board (see FIG. 5).

The participant can grasp un-contracted data of the participant by confirming the contract data written in the general-purpose data bulletin board. Alternatively, the trading management server 10 may specify the contracted TXID, and write, in the general-purpose data bulletin board, deletion data indicating that the TXID is deleted from a place of trading. The participant may grasp bid data remaining in the place of trading (un-contracted bid data) in accordance with the deletion data.

The seller and the buyer access the general-purpose data bulletin board to acquire the contract data, and confirm the trading result (step S06, step S07). The participant terminal 20 (seller terminal, buyer terminal) acquires the contract data written in the general-purpose data bulletin board to confirm whether or not the bid of the participant terminal itself is contracted.

The participant terminal 20 can grasp a state of the bid data of the participant terminal itself (contracted or un-contracted) by referencing the contract data. Alternatively, the participant terminal 20 may confirm whether or not the bid of the participant terminal itself is contracted by confirming the deletion data.

The participant terminal 20 can confirm that the bid of the participant terminal itself is contracted when the TXID written in the contract data corresponds to the bid of the participant terminal itself. On the other hand, when the TXID written in the contract data does not correspond to the bid of the participant terminal itself, the participant terminal 20 can grasp that the bid of the participant terminal itself is not contracted and remains as an un-contracted bid in the general-purpose data bulletin board (place of trading).

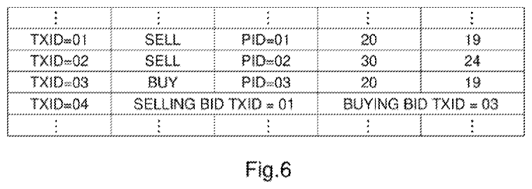

For example, assume that the electricity trading data (including pieces of bid data and contract data) as illustrated in FIG. 6 is written in the general-purpose data bulletin board. FIG. 6 indicates that selling bids having the TXID of “01” and “02” are executed, and thereafter, a buying bid having the TXID of “03” is executed. After that, the selling bid having the TXID of “01” and the buying bid having the TXID of “03” are contracted, and the contract data having the TXID of “04” is written in the general-purpose data bulletin board. Note that “PID” illustrated in FIG. 6 represents the participant ID.

The trading management server 10 and the participant terminal 20 can confirm the electricity trading data (bid data, contract data) as illustrated in FIG. 6 to confirm also that the selling bid having the TXID of “02” remains as un-contracted bid data in the general-purpose data bulletin board.

In other words, the trading management server 10 traces the electricity trading data written in the general-purpose data bulletin board from when the system starts operation to thereby grasp the latest bid state (the bid data remaining in an un-contracted state). Similarly, the participant terminal 20 traces the electricity trading data written in the general-purpose data bulletin board to thereby grasp the latest bid state.

However, the participant terminal 20 can grasp the state related to the bid of the participant terminal itself (contracted or un-contracted), but cannot know details of the bid data remaining in the general-purpose data bulletin board (at least details of the price) because the bid data is encrypted.

### [Processing Configuration of Trading Server]

Next, details of the trading management server 10 are described. The trading management server 10 acquires the bid data written in the general-purpose data bulletin board to decrypt the encrypted price. Furthermore, the trading management server 10 uses the decrypted price to execute trading through Zaraba method.

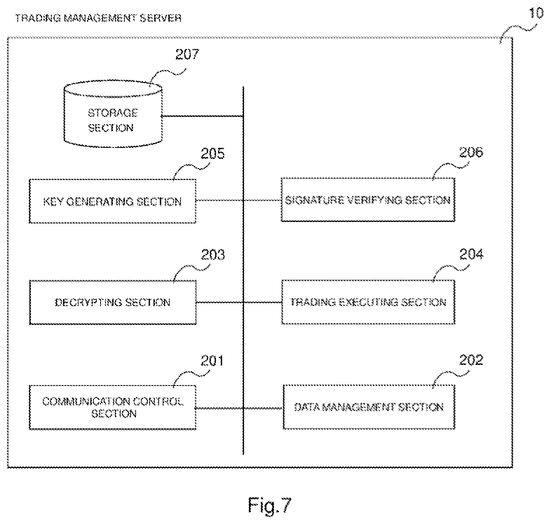

FIG. 7 is a block diagram illustrating an example of a processing configuration of the trading management server 10 according to the first example embodiment. With reference to FIG. 7, the trading management server 10 is configured to include a communication control section 201, a data management section 202, a decrypting section 203, a trading executing section 204, a key generating section 205, a signature verifying section 206, and a storage section 207.

The communication control section 201 is a means for achieving communication with other apparatuses (mainly the management server 40). The communication control section 201 is also a means for sorting messages (packets) received from other apparatuses into processing modules, or a means for transmitting messages acquired from the respective processing modules to other apparatuses.

The key generating section 205 is a means for generating a key pair of a public key and a private key. The public key is disclosed in public, and the private key is stored in the storage section 207.

The signature verifying section 206 is a means for verifying the signature of the participant terminal 20 appended to the bid data. The bid data of which the signature is successfully verified is handled as legitimate bid data.

The storage section 207 is a means for storing information or the like required for processing the processing modules.

The data management section 202 is a means for accessing the general-purpose data bulletin board to manage the electricity trading data (bid data and contract data). The data management section 202 periodically accesses the general-purpose data bulletin board to acquire bid data that is newly written in the bulletin board (or that is never once acquired by the trading management server 10). The data management section 202 passes the acquired bid data to the decrypting section 203. The data management section 202 writes the trading result (contract data) acquired through the trading executing section 204 in the general-purpose data bulletin board via the communication control section 201.

The decrypting section 203 is a means for decrypting the bid data encrypted with the public key of the trading management server 10. To be more specific, the decrypting section 203 decrypts the encrypted bid data using the private key to store a decrypting result (the bid data in a plain text) in the storage section 207.

The trading executing section 204 is a means for executing trading (electricity trading) using the bid data. The trading executing section 204 achieves the electricity trading through a scheme of the so-called Zaraba method. To be more specific, the trading executing section 204 concludes trading in order of matching of the price and the quantity among many selling bids and buying bids.

The trading executing section 204 concludes the trading in compliance with the “general rule of price priority” and the “general rule of time priority”. For example, the trading is concluded, where in a case of a buy order (buying bid), a buy order with a higher price is prioritized over a buy order with a lower price, and in a case of a sell order, a sell order with a lower price is prioritized over a sell order with a higher price. In a case of orders with the same price, the order earlier bid is prioritized to conclude the trading.

The trading executing section 204 uses a “bid management table” to manage the bid state (un-contracted bid data), and uses the table to execute trading. The bid management table is table information in which un-contracted bid prices are arranged in an order for each of the sell order and the buy order. In other words, the un-contracted bid data is managed through the bid management table.

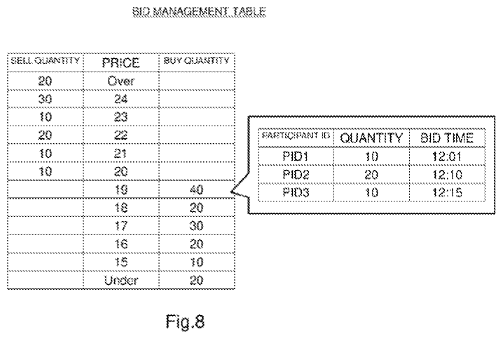

FIG. 8 is a diagram illustrating an example of the bid management table. As illustrated in FIG. 8, the quantities of the un-contracted bid data are arranged in order of price, and managed. Note that in the drawings including FIG. 8, a unit of quantity (sell quantity, buy quantity) and a unit of price are not indicated, and these units can be arbitrary. For example, a unit of quantity may be “kWh”, and a unit of price may be “1 yen”.

The trading executing section 204 or the data management section 202 trace the electricity trading data written in the general-purpose data bulletin board from when the system starts operation so that the bid management table can be created as illustrated in FIG. 8.

Here, as described above, the electricity trading by the trading executing section 204 is executed in compliance with the general rule of price priority and the general rule of time priority. Thus, management using a simple combination of only the price and the quantity as illustrated in FIG. 8 is not performed, but, in practice, details of the bid data included in each price are managed. For example, as illustrated by a balloon in FIG. 8, details of the un-contracted bid data (participant ID, quantity, and bid time) are managed per price.

Note that, for the participant ID and the quantity, information written in the bid data may be used. For the bid time, a generation date and time of the bid data or a time (time stamp) recorded in the bulletin board may be used. In a case that the trading executing section 204 contracts a selling bid and a buying bid, the trading executing section 204 reflects a result of the contract to the bid management table.

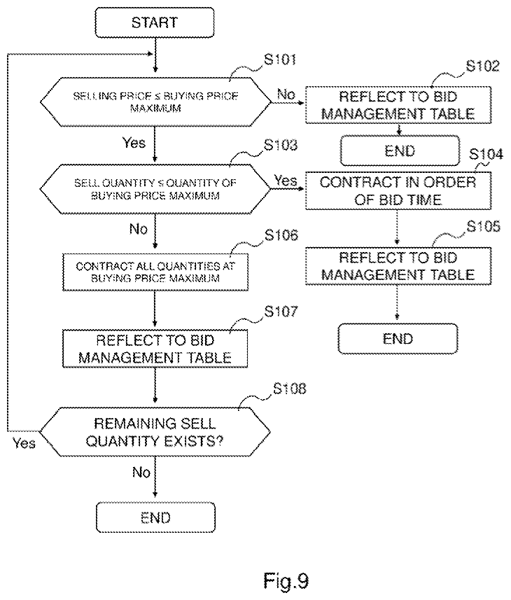

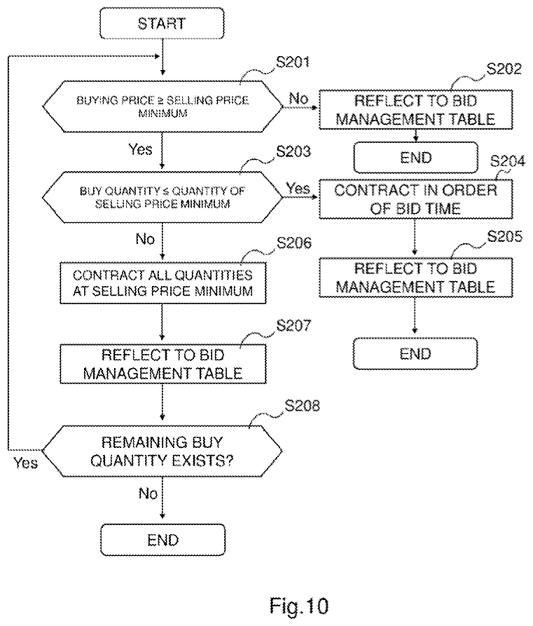

Subsequently, with reference to FIG. 9 and FIG. 10, an operation the trading executing section 204 is described.

The trading executing section 204 acquires the bid data stored in the storage section 207 and processes the bid data in order from old bid time (time stamp).

At this time, in a case that the bid data is the “seller bid data”, the trading executing section 204 performs processing in accordance with a flowchart illustrated in FIG. 9. In a case that the bid data is the “buyer bid data”, the trading executing section 204 performs processing in accordance with a flowchart illustrated in FIG. 10.

First, the operation of the trading executing section 204 in the case that the bid data is the “seller bid data” is described.

In step S101 illustrated in FIG. 9, the trading executing section 204 determines whether a selling price (desired selling price) of the seller bid data to be processed is equal to or less than a maximum of a buying price (desired buying price) managed through the bid management table. For example, in the example illustrated in FIG. 8, the selling price and the maximum “19” of the buying price are compared concerning which is higher.

When the selling price is higher than the maximum of the buying price (step S101, No branch), the trading executing section 204 reflects the seller bid data to be processed to the bid management table, and then, terminates the processing (step S102).

When the selling price is equal to or less than the maximum of the buying price (step S101, Yes branch), the trading executing section 204 determines whether the sell quantity (desired selling amount of electricity) is equal to or less than the quantity of the buying price maximum (step S103). For example, in the example illustrated in FIG. 8, the sell quantity and the quantity “40” of the buying price maximum are compared concerning which is higher.

When the sell quantity is equal to or less than the quantity of the buying price maximum (step S103, Yes branch), the trading executing section 204 contracts the buying bid in order from old bid time (step S104). For example, in the example illustrated in FIG. 8, when the sell quantity is “30”, the selling bid, and the buying bid at the oldest bid time (bid time; 12:01) and the buying bid at the second oldest bid time (bid time; 12:10) are contracted.

The trading executing section 204 reflects a trading result (contract result) to the bid management table, and then, terminates the processing (step S105).

When the sell quantity is higher than the quantity of the buying price maximum (step S103, No branch), the trading executing section 204 contracts all of the sell quantities of the targeted selling bids at buying price maximum (step S106).

The trading executing section 204 reflects a trading result (contract result) to the bid management table (step S107).

In step S108, the trading executing section 204 determines whether the sell quantity not contracted in the processing in step S106 exists among the sell quantities of the seller bid data. For example, in the example illustrated in FIG. 8, when the sell quantity is “50”, the sell quantity “40” is contracted at the buying price maximum “19”, and the number of remaining sell quantities is “10”.

When the remaining sell quantity exists (step S108, Yes branch), the trading executing section 204 returns to step S101 to continue the processing. Specifically, the trading executing section 204 uses the bid management table to which a result of contract of some sell quantities is reflected to process the selling remaining. For example, in the above example, the number “10” of selling remaining quantities are to be contracted with a buying bid at the price “18”.

When the remaining sell quantity does not exist (step S108, No branch), the trading executing section 204 terminates the processing.

Next, the operation of the trading executing section 204 in the case that the bid data is the “buyer bid data” is described.

In step S201 illustrated in FIG. 10, the trading executing section 204 determines whether a buying price (desired buying price) of the buyer bid data to be processed is equal to or more than a minimum of a selling price (desired selling price) managed through the bid management table.

When the buying price is lower than the minimum of the selling price (step S201, No branch), the trading executing section 204 reflects the buyer bid data to be processed to the bid management table, and then, terminates the processing (step S202).

When the buying price is equal to or more than the minimum of the selling price (step S201, Yes branch), the trading executing section 204 determines whether the buy quantity (desired buying amount of electricity) is equal to or less than the quantity of the selling price minimum (step S203).

When the buy quantity is equal to or less than the quantity of the selling price minimum (step S203, Yes branch), the trading executing section 204 contracts the seller bid in order from old bid time (step S204).

The trading executing section 204 reflects a trading result (contract result) to the bid management table, and then, terminates the processing (step S205).

When the buy quantity is higher than the quantity of the selling price minimum (step S203, No branch), the trading executing section 204 contracts all of the buy quantities of the targeted buying bids at selling price minimum (step S206).

The trading executing section 204 reflects a trading result (contract result) to the bid management table (step S207).

In step S208, the trading executing section 204 determines whether the buy quantity not contracted in the processing in step S206 exists among the buy quantities of the buyer bid data.

When the remaining buy quantity exists (step S208, Yes branch), the trading executing section 204 returns to step S201 to continue the processing.

When the remaining buy quantity does not exist (step S208, No branch), the trading executing section 204 terminates the processing.

The trading executing section 204 stores, after the data management section 202 terminates the processing related to the newly acquired bid data, the trading result (contract data) in the storage section 207 as needed. The data management section 202 writes the above-described trading result (contract data) acquired through the trading executing section 204 in the general-purpose data bulletin board via the communication control section 201. At this time, the data management section 202 appends the signature of (the trading management server 10) itself to the contract data or the like.

### [Processing Configuration of Participant Terminal]

Next, details of the participant terminal 20 are described.

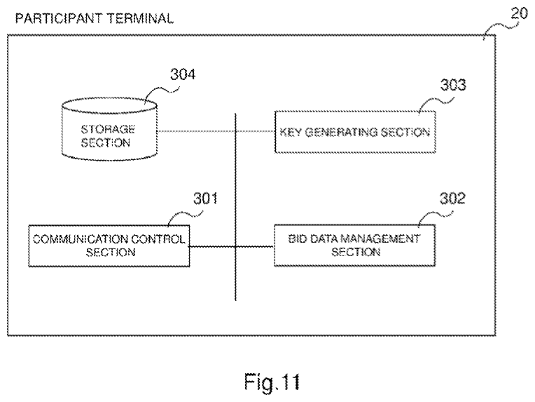

FIG. 11 is a block diagram illustrating an example of a processing configuration of the participant terminal 20 according to the first example embodiment. With reference to FIG. 11, the participant terminal 20 is configured to include a communication control section 301, a bid data management section 302, a key generating section 303, and a storage section 304.

The communication control section 301 is a means for achieving communication with other apparatuses (mainly the management server 40). The communication control section 301 is also a means for sorting messages (packets) received from other apparatuses into processing modules, or a means for transmitting messages acquired from the respective processing modules to other apparatuses.

The key generating section 303 is a means for generating a key pair of a public key and a private key. The public key is disclosed in public, and the private key is stored in the storage section 304.

The storage section 304 is a means for storing information or the like required for processing the processing modules. For example, the storage section 304 stores the public key disclosed in public from the trading management server 10. The public key is used for the bid data management section 302 to verify the signature. Specifically, the public key of the trading management server 10 stored in the storage section 304 has a role of a “signature verification key” in the participant terminal 20.

The bid data management section 302 is a means for managing the bid data (seller bid data and buyer bid data). Specifically, the bid data management section 302 generates the bid data as illustrated in FIG. 4 in response to an operation by a user (seller or buyer).

Furthermore, the bid data management section 302 uses the private key of the terminal itself to append a signature to the generated bid data, and thereafter, uses the public key of the trading management server 10 to encrypt the bid data. Then, the bid data management section 302 writes the encrypted bid data in the general-purpose data bulletin board. Here, the reason why the bid data management section 302 appends the signature and thereafter, encrypts the bid data is for preventing the matter that the signature for the bid data of the same participant is verified by the public key of the participant and the bid data of the same participant is associated with each other. Note that the signature generation by the participant terminal 20 is performed using the private key of the participant terminal 20, and thus, the private key has a role of a “signature key”.

The bid data management section 302 acquires the contract data written in the general-purpose data bulletin board. The bid data management section 302 verifies the signature of the trading management server 10 appended to the contract data, and in a case of succeeding in the signature verification, accepts the contract data as legitimate data. The bid data management section 302 determines that the bid of the terminal itself is contracted in a case that the acquired contract data has the TXID given to the bid data of the terminal itself. At this time, the bid data management section 302 may display the contract result on a liquid crystal display and so on.

### [Management Server]

The management server 40 constituting the data management system 30 is an apparatus using the blockchain technology to provide the electronic bulletin board (general-purpose data bulletin board).

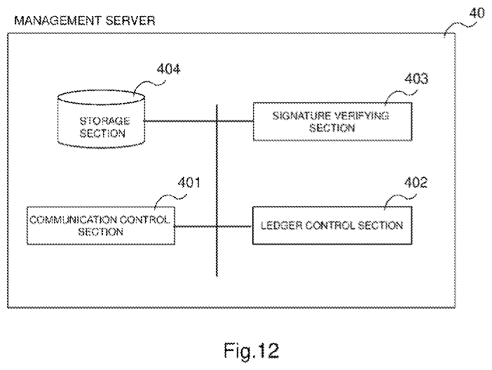

FIG. 12 is a block diagram illustrating an example of a processing configuration of the management server 40 according to the first example embodiment. With reference to FIG. 12, the management server 40 is configured to include a communication control section 401, a ledger control section 402, a signature verifying section 403, and a storage section 404.

The communication control section 401 is a means for achieving communication with other apparatuses. The communication control section 401 is also a means for sorting messages (packets) received from other apparatuses into processing modules, or a means for transmitting messages acquired from the respective processing modules to other apparatuses.

The storage section 404 is a means for storing information or the like required for processing the processing modules. For example, the storage section 404 stores a ledger for achieving the electronic bulletin board (general-purpose data bulletin board) by the blockchain.

The ledger control section 402 controls creation of a transaction to be written in the ledger and creation of a message related to consensus building for writing the transaction in the ledger. Every time the ledger control section 402 is requested to write the electricity trading data in the general-purpose data bulletin board from the trading management server 10 or the participant terminal 20, the ledger control section 402 additionally writes the data in a shared ledger (general-purpose data management ledger). In additionally writing the data, each management server 40 performs consensus building. A method of consensus building may use a Practical Byzantine Fault Tolerance (PBFT) protocol, for example. Note that the electronic bulletin board using the blockchain is known to those of ordinary skill in the art, and thus, a further description of the ledger control section 402 is omitted.

The signature verifying section 403 is a means for verifying the signature of another management server 40 when building a consensus with such another management server 40. In a case that the signature is successfully verified, received data is handled as legitimate data and written in the blockchain.

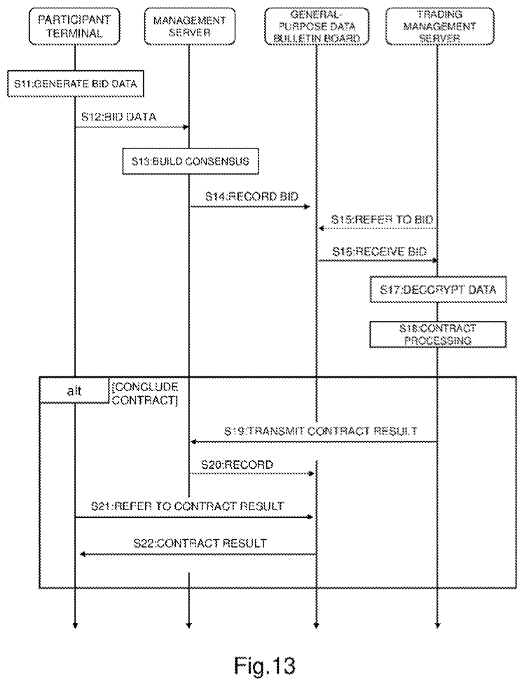

Subsequently, an operation of the electronic trading system according to the first example embodiment is described with reference to the drawings. FIG. 13 is a sequence diagram illustrating an example of the operation of the electronic trading system according to the first example embodiment.

The participant terminal 20 generates bid data (step S11). For example, the participant terminal 20 generates the bid data as illustrated in the upper row in FIG. 4.

The participant terminal 20 appends a signature to the bid data, and thereafter, encrypts the signed bid data with the public key of the trading management server 10 to transmit the encrypted bid data to the data management system 30 (the management server 40) (step S12). Note that the participant terminal 20 desirably uses, for example, a probabilistic encryption to generate an encrypted text of the bid data in order to prevent the participant from being specified. Note that the bid data is encrypted and is not obvious at first glance in terms of contents of information, and thus, the participant terminal 20 may provide a tag for indicating that the data written in the general-purpose data bulletin board is the bid data. The tag may be any data so long as the trading management server 10 can recognize that data, and for example, may be a text “bid data” or the like.

Each of the plurality of management servers 40 constituting the data management system 30 verifies the signature appended to the received data by another management server 40. Each management server 40, in a case of succeeding in the signature verification, builds a consensus for the data to be written in the shared ledger (step S13). Each management server 40 uses, for example, an algorithm such as Multisig and PBFT to build a consensus.

When the consensus is built between the plurality of management servers 40, the bid data is recorded in the shared ledger (the general-purpose data management ledger) (step S14).

The trading management server 10 accesses the general-purpose data bulletin board to confirm whether new bid data exits (step S15).

In a case that new bid data is written in the general-purpose data bulletin board, the trading management server 10 acquires the bid data (step S16).

The trading management server 10 decrypts the encrypted bid data (step S17). Then, the trading management server 10 verifies the signature appended to the decrypted bid data. In a case that the signature is invalid, the trading management server 10 ignores (discards) the bid data.

The trading management server 10 confirms contents of the trading written in the bid data to execute the contract processing (step S18).

In a case that the bid data is contracted, the trading management server 10 transmits the contract data to the data management system 30 (the management server 40) (step S19). Note that the contract data includes the IDs of two pieces of contracted bid data as illustrated in FIG. 5. The trading management server 10 appends a signature to the contract data and transmits the signed contract data to the data management system 30.

Each management server 40 writes the acquired contract data in the general-purpose data bulletin board (step S20).

The participant terminal 20 accesses the general-purpose data bulletin board to confirm (inquire) whether new contract data exists (step S21).

The management server 40 transmits the new contract data to the participant terminal 20 (step S22). In a case that a valid signature is appended to the contract data, the participant terminal 20 handles the new contract data read from the general-purpose data bulletin board as legitimate data.

As described above, in the electronic trading system according to the first example embodiment, the participant encrypts bid data of the participant with the public key of the trading management server 10 and registers the encrypted bid data in the general-purpose data bulletin board. The encrypted bid data can be decrypted by the trading management server 10 having the private key, and the participant (the participant terminal 20) cannot know contents of that bid data. As a result, confidentiality or privacy of information related to the bid is maintained, and the electronic trading system according to the first example embodiment can provide a fair trading.

In the electronic trading system according to the first example embodiment, the electricity trading data (bid data, contract data) is exchanged via the electronic bulletin board (general-purpose data bulletin board) achieved by the blockchain technology. As a result, a fraud or like in the contract data by the trading management server 10 (data alteration or the like) can be prevented.

### Second Example Embodiment

Subsequently, a second example embodiment is described in more detail with reference to the drawings.

The first example embodiment describes the electricity trading system in which the trading price or the trading volume which are commercially subtle information can be concealed. However, the electronic trading system according to the first example embodiment may have a room for missing a fraud by the trading management server 10. For example, the trading management server 10 intending a fraud can contract a trading that is originally not allowed to be contracted.

The second example embodiment describes an electronic trading system for preventing such a fraudulent activity by the trading management server 10.

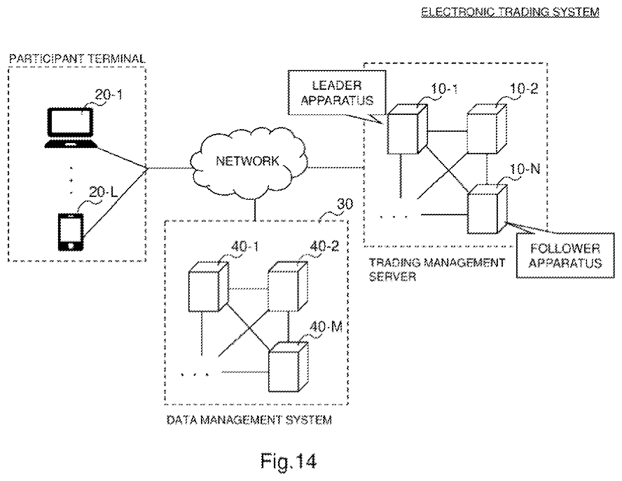

FIG. 14 is a diagram illustrating an example of a configuration of the electronic trading system according to the second example embodiment; As illustrated in FIG. 14, the electronic trading system according to the second example embodiment includes a plurality of trading management servers 10-1 to 10-N (N is an integer of 3 or more, which applies to the following). The trading management servers 10-1 to 10-N, in a case of no special reason for being distinguished, are expressed merely as the “trading management server 10”.

Note that assume that most (for example, over half) of the plurality of trading management servers 10 described above do not do a fraudulent activity. In other words, most of the trading management servers 10 included in the system do not perform fraudulent contract processing.

Here, one leader apparatus (main apparatus) is selected from among the plurality of trading management servers 10. Note that selection of the leader apparatus may be determined by a system administrator to input the determined selection to the leader apparatus, or may be determined between the trading management servers 10. For example, the leader apparatus may be selected based on a random number, or in a round-robin manner.

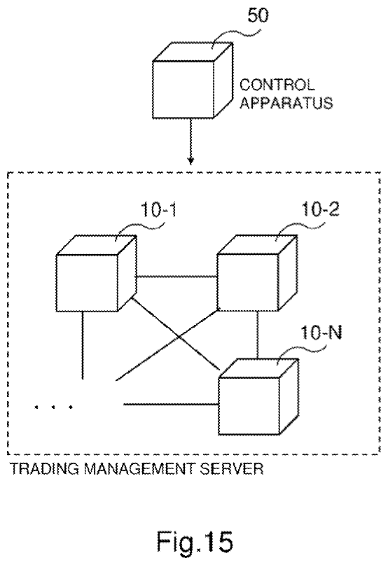

Alternatively, as illustrated in FIG. 15, a control apparatus 50 that is a higher-layer apparatus of the trading management server 10 may select the leader apparatus to notify the trading management server 10 (leader apparatus, follower apparatuses) of a result of the selection.

Each of the trading management servers 10 other than the leader apparatus among the plurality of trading management servers 10 included in the electronic trading system operates as a follower apparatus (sub-apparatus). At least each of the plurality of follower apparatuses generates an electronic bulletin board (a trading data bulletin board described later) for managing un-contracted bid data.

In the description below, a result of the contract processing by the leader apparatus is expresses as “provisional contract data”.

The trading management server 10 as the leader apparatus performs the contract processing on new bid data read from the general-purpose data bulletin board provided by the data management system 30. The leader apparatus transmits a result of the contract processing (contract or un-contracted) and the new bid data read from the general-purpose data bulletin board to other trading management servers 10 (the plurality of follower apparatuses). At this time, the leader apparatus appends a signature to the result of the contract processing.

The leader apparatus broadcasts the signed provisional contract data described above to the plurality of follower apparatuses. Alternatively, the leader apparatus may transmit the signed provisional contract data to the follower apparatuses in a predetermined order.

For example, as illustrated in FIG. 14, in a case that the trading management server 10-1 operates as the leader apparatus, the trading management server 10-1 transmits to the trading management servers 10-2, 10-3, . . . , 10-N the provisional contract data to which a signature of the trading management server itself is appended.

Here, the plurality of trading management servers 10 configure individual electronic bulletin boards different from the electronic bulletin board (general-purpose data bulletin board) provided by the data management system 30. Note that in the disclosure of the present application, the electronic bulletin board configured by the trading management server 10 is expressed as the “trading data bulletin board”. The electronic bulletin board configured by the trading management server 10 is configured based on the trading data management ledger. Note that the trading data bulletin board is also operated and managed using the blockchain technology.

Each of the plurality of trading management servers 10 including the leader apparatus uses the trading data management ledger described above to store the information of the “bid management table” described in the first example embodiment. In other words, the information of the bid management table is written in the trading data bulletin board.

The follower apparatuses verify legitimacy of the provisional contract data acquired from the leader apparatus.

First, each of the follower apparatuses verifies the signature appended to the provisional contract data acquired from the leader apparatus. In a case that the signature appended to the provisional contract data is illegitimate, each follower apparatus discards the provisional contract data. In a case that the signature appended to the provisional contract data is legitimate, each follower apparatus successfully verifies the legitimacy of the provisional contract data.

Specifically, each follower apparatus uses the bid management table written in the trading data management ledger held by the follower apparatus itself and the new bid data acquired from the leader apparatus to perform the contract processing. Each follower apparatus determines whether a contract result of the follower apparatus itself matches a result of the provisional contract data received from the leader apparatus.

When these two contract results match, each follower apparatus sets a verification result of the provisional contract data to “acceptable”. In contrast, when these two contract results do not match, each follower apparatus sets the verification result of the provisional contract data to “unacceptable”.

Each follower apparatus broadcasts the verification result (acceptable or unacceptable) of the follower apparatus itself to other follower apparatuses (other trading management servers 10 except for the leader apparatus). Note that each follower apparatus appends a signature to the verification result described above and broadcasts the verification result to which the signature is appended.

Each follower apparatus, once acquiring the verification result from another follower apparatus, verifies the signature appended to the verification result. Each follower apparatus, in a case of failing in the signature verification, discards the acquired verification result. Each follower apparatus, in a case of succeeding in the signature verification, performs consensus building processing on whether to accept the provisional contract data.

Specifically, each follower apparatus confirms whether the verification results of a certain number or more of the follower apparatuses (i.e., the follower apparatuses including this follower apparatus itself, or the follower apparatuses except of the leader apparatus) included in the system are “the provisional contract data is acceptable”. Note that the certain number for determining whether to accept the provisional contract data varies depending on the consensus building scheme.

For example, assume a case that the MinBFT consensus building protocol is used and the number of trading management servers 10 included in the electronic trading system is six (N=6). In the MinBFT consensus building protocol, the above-described certain number is “over half”. The number of follower apparatuses included in the system is five. Accordingly, it is determined as to whether three or more follower apparatuses of five follower apparatuses obtain the result of “provisional contract data is acceptable”.

When a certain number or more of follower apparatuses among a plurality of follower apparatuses obtain the conclusion of “provisional contract data is acceptable”, the result of the contract processing by the leader apparatus (provisional contract data) is determined to be legitimate, and a consensus to that effect is generated. In this case, each follower apparatus reflects the new bid data and the provisional contract data to the trading data management ledger (the bid management table) managed by the follower apparatus itself.

Unless the certain number or more of follower apparatuses among the plurality of follower apparatuses do obtain the conclusion of “provisional contract data is acceptable”, the result of the contract processing by the leader apparatus (provisional contract data) is determined to be illegitimate, and a consensus to that effect is generated. In this case, each follower apparatus discards the provisional contract data and new bid data acquired from the leader apparatus.

The leader apparatus accesses the trading data bulletin board generated by each follower apparatus after a prescribed time elapses from transmitting the provisional contract data. The leader apparatus confirms whether the new bid data and the provisional contract data are reflected to the trading data bulletin board.

In a case that the contents of the provisional contract data or the like are reflected to the trading data bulletin board, the leader apparatus determines that a consensus by the follower apparatuses on the result of the contract processing of the leader apparatus itself is obtained. In this case, the leader apparatus reflects the new bid data and the provisional contract data to the trading data management ledger of the leader apparatus itself. Furthermore, the leader apparatus writes the result of the contract processing in the general-purpose data bulletin board as needed. Specifically, the leader apparatus writes the contract data described in the first example embodiment in the general-purpose data bulletin board.

In a case that the contents of the provisional contract data or the like are not reflected to the trading data bulletin board, the leader apparatus determines that a consensus by the follower apparatuses on the result of the contract processing of the leader apparatus itself is not obtained. In this case, the leader apparatus performs a predetermined error processing (for example, a prescribed number of retry processing, or the like).

In this way, each of the plurality of follower apparatuses verifies the legitimacy of the contract result of the leader apparatus. Each of the plurality of follower apparatuses, in a case of obtaining the consensus, with other follower apparatuses, that the contract result of the leader apparatus is legitimate, reflects the contract result of the leader apparatus to the trading data bulletin board. In the case that the contract result of the leader apparatus is written in the electronic bulletin board (trading data bulletin board), the leader apparatus reflects the contract result of the leader apparatus itself to the electronic bulletin board (general-purpose data bulletin board) provided by the data management system 30.

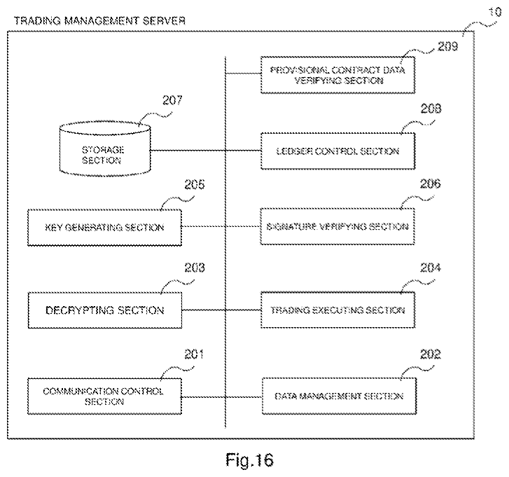

FIG. 16 is a diagram illustrating an example of the processing configuration (processing module) of the trading management server 10 according to the second example embodiment. With reference to FIG. 16, a ledger control section 208 and a provisional contract data verifying section 209 are added to the trading management server 10 according to the first example embodiment.

The ledger control section 208 is a means for controlling the ledger (trading data management ledger) similar to the first example embodiment.

The provisional contract data verifying section 209 is a means for verifying whether to accept the provisional contract data acquired from the leader apparatus.

Note that each of the plurality of trading management servers 10 needs the private key and the public key (the private key and public key for decrypting the bid data), and these keys can be shared with the respective trading management servers 10. For example, the leader apparatus may generate a key pair of the private key and the public key to deliver the key pair to the follower apparatuses.

First, a case that the trading management server 10 operates as the leader apparatus is described.

In this case, the trading executing section 204 transmits the new bid data and the result of the contract processing (provisional contract data) to other follower apparatuses. Then, after the prescribed time elapses, the trading executing section 204 accesses the trading data bulletin board to confirm whether the provisional contract data or the like is reflected. In a case that the provisional contract data or the like is reflected to the trading data bulletin board, the trading executing section 204 notifies the ledger control section 208 and the data management section 202 of that effect.

The ledger control section 208 reflects the new bid data and the provisional contract data to the trading data management ledger managed by the ledger control section 208 itself.

The data management section 202 transmits the contract data via the communication control section 201 to the data management system 30 as needed. At this time, the data management section 202 transmits a pointer along with the contract result (contract data) to the management server 40. The transmitted pointer is recorded in the general-purpose data bulletin board. Details of the above-described pointer are described later.

Note that the trading executing section 204 in the leader apparatus transmits, after transmitting the provisional contract data described above, the transaction ID identifying the transmission of the provisional contract data (transaction) to the management server 40 (data management system 30). The transaction ID is recorded in the general-purpose data bulletin board. In other words, the leader apparatus writes, in the general-purpose data bulletin board, the transaction ID at the time of transmitting the contract result of the leader apparatus itself to the plurality of follower apparatuses.

Subsequently, a case that the trading management server 10 operates as the follower apparatus is described.

In this case, the communication control section 201, once acquiring the provisional contract data and the new bid data from the leader apparatus, passes these pieces of data to the provisional contract data verifying section 209.

The provisional contract data verifying section 209 passes the new bid data to the trading executing section 204 and instructs to execute the contract processing using the new bid data. The provisional contract data verifying section 209 obtains the contract result (whether the new bid data is contracted or un-contracted) from the trading executing section 204. The provisional contract data verifying section 209 determines that “the provisional contract data is acceptable” or “the provisional contract data is unacceptable” based on the result of the provisional contract data and result of the trading executing section 204.

The provisional contract data verifying section 209 transmits the verification result (acceptable or unacceptable) to other follower apparatuses.

The provisional contract data verifying section 209 determines whether the result of the contract processing by the leader apparatus (provisional contract data) is legitimate based on the verification results received from other follower apparatuses. The provisional contract data verifying section 209 determines that the provisional contract data is legitimate in a case that a certain number or more of follower apparatuses including the trading management server itself determine that “the provisional contract data is acceptable”. In this case, the provisional contract data verifying section 209 determines that a consensus that the contract result of the leader apparatus is legitimate is built with other follower apparatuses, and the provisional contract data verifying section 209 passes the new bid data and the provisional contract data to the ledger control section 208. The ledger control section 208 writes these pieces of data in the trading data bulletin board (or reflects the data to the bid management table).

Subsequently, an operation of the trading management server 10 according to the second example embodiment is described with reference to the drawings.

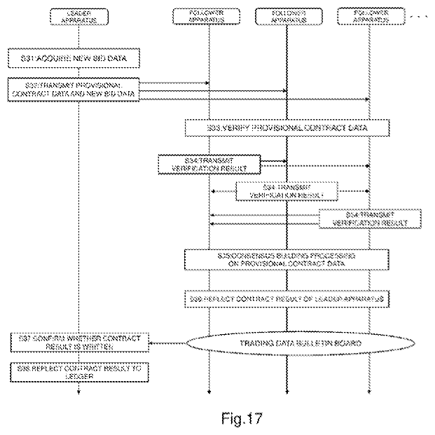

FIG. 17 is a sequence diagram illustrating an example of the operation of the trading management server (leader apparatus and follower apparatus) 10 according to the second example embodiment.

The leader apparatus acquires new bid data from the general-purpose data bulletin board (step S31).

The leader apparatus uses the new bid data to execute the contract processing. The leader apparatus transmits a result of the contract processing (whether the new bid data is contracted or the new bid data is un-contracted) as provisional contract data to the follower apparatuses (step S32). At this time, the leader apparatus transmits also the new bid data acquired from the general-purpose data bulletin board to the follower apparatuses.

Each follower apparatus verifies the provisional contract data acquired from the leader apparatus (step S33). Specifically, each follower apparatus executes the contract processing, based on the acquired provisional contract data and the bid management table managed by the follower apparatus itself.

Each follower apparatus compares the result of the provisional contract data acquired from the leader apparatus with the result of the contract processing of the follower apparatus itself. In a case that two processing results match, each follower apparatus sets the verification result to “provisional contract data is acceptable”. In a case that two processing results do not match, each follower apparatus sets the verification result to “provisional contract data is unacceptable”.

Each follower apparatus transmits the verification result of the provisional contract data to other follower apparatuses (step S34).

Each follower apparatus performs the consensus building processing related to the provisional contract data, based on the verification results broadcast from other follower apparatuses (step S35). Specifically, each follower apparatus determines that the contract result of the leader apparatus is legitimate when the verification results of a certain number or more of follower apparatuses are “provisional contract data is acceptable”. In this case, it is determined that a consensus that the contract processing by the leader apparatus is legitimate is built between the follower apparatuses.

Once the consensus that the contract processing by the leader apparatus is legitimate is generated, each follower apparatus reflects the result of the contract processing by the leader apparatus to the trading data bulletin board (step S36).

The leader apparatus, after the prescribed time elapses from transmitting the provisional contract data or the like to the follower apparatuses, accesses the trading data bulletin board to confirm whether the contract result of the leader apparatus itself (provisional contract data) is reflected to that bulletin board (step S37).

In a case that the contract result of the leader apparatus itself is correctly reflected to the trading data bulletin board, the leader apparatus reflects the contents of the new bid data and the provisional contract data also to the trading data management ledger of the leader apparatus itself (step S38).

In a case that the contract processing of the leader apparatus itself is approved (or in a case that the legitimacy of the provisional contract data is confirmed), the leader apparatus writes the contract data in the general-purpose data bulletin board as needed (not illustrated in FIG. 17).

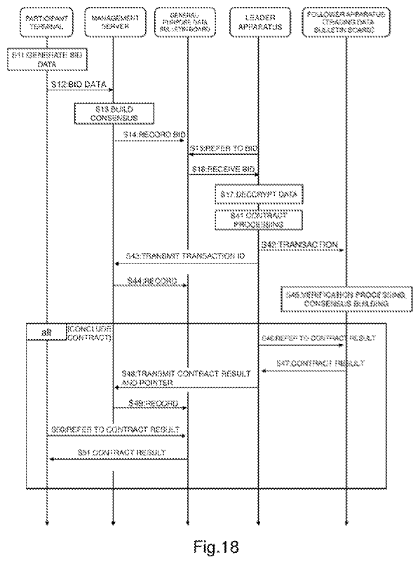

Subsequently, an operation of the electronic trading system according to the second example embodiment is described with reference to the drawings. FIG. 18 is a sequence diagram illustrating an example of the operation of the electronic trading system according to the second example embodiment. In FIG. 18, an operation that can be the same as the operation of the electronic trading system according to the first example embodiment is denoted by the same reference sign (step name), and the description thereof is omitted. Specifically, steps S11 to S17 can be the same between the first and second example embodiments, and thus, detailed descriptions of processing thereof are omitted.

The leader apparatus of the plurality of trading management servers 10 performs the contract processing using the new bid data (step S41).

The leader apparatus generates a transaction including the result of the contract processing (provisional contract data) and the new bid data, and transmits the generated transaction to other trading management servers 10 (follower apparatuses) (step S42).

The leader apparatus transmits a transaction ID corresponding to the generated transaction to the management server 40 (step S43).

The management server 40 receiving the transaction ID described above records the received transaction ID in the electronic bulletin board (general-purpose data management ledger) (step S44).

The follower apparatus receiving the transaction from the leader apparatus performs processing of verification and consensus building on the contract processing of the leader apparatus (step S45). Such processing overlaps the content described using FIG. 17 and the like, and thus, a further description thereof is omitted.

The leader apparatus accesses the electronic bulletin board (trading data bulletin board) to confirm whether the contract processing of the leader apparatus itself is approved. Specifically, the leader apparatus accesses the trading data bulletin board to confirm whether the contract result of the leader apparatus itself is reflected to the electronic bulletin board (steps S46, S47).

The leader apparatus refers to a new record in the trading data bulletin board to confirm that the contract result of the leader apparatus itself is reflected to the trading data bulletin board, and then, transmits the contract result and the pointer to the contract result to the management server 40 (step S48). The management server 40 records the received contract result and the pointer for the received contract result in the general-purpose data bulletin board (step S49).

The pointer to the contract result is, for example, a header of a block of the blockchain constituting the trading data bulletin board. The leader apparatus records the header of the block to which the contract processing of the leader apparatus itself is reflected as of “the pointer to the contract result” in the general-purpose data bulletin board. Note that the header of the block includes the content of the block and a hash value of a header of a preceding block. Accordingly, when the content of the block is posteriorly altered, the alteration of the block can be detected by referring to the block header.

As described above, the leader apparatus transmits the provisional contract data to the follower apparatuses, and then, writes the ID of the transaction including the provisional contract data in the general-purpose data bulletin board. In a case that the contract result for the provisional contract data is approved by the follower apparatuses, the leader apparatus writes the pointer to the contract result (for example, a hash value of input data and output data) in the general-purpose data bulletin board.

In this way, the leader apparatus writes an input transaction to the blockchain and the pointer to the contract result in the general-purpose data bulletin board so that even if an illegitimate result is written in the trading data management ledger (or the content of the trading is falsified), the third party can detect that fraudulent activity. Specifically, the third party executes the contract processing in accordance with the information written in the general-purpose data bulletin board to calculate a hash value the same as the pointer described above (a hash value of the input data and the output data). After that, the third party compares the calculated hash value with the hash value written in the general-purpose data bulletin board to confirm that two hash values match so that the third party can confirm no fraudulent activity by the trading management server 10.

The detection of fraudulent activity described above is effective in a case that, for example, the assumption that over half of the plurality of trading management servers 10 (the plurality of follower apparatuses) do not do a fraudulent activity is broken, and an illegitimate contract result is written in the trading data bulletin board. In other words, if the trading management server 10 does a fraudulent activity, a hash value written in the general-purpose data bulletin board (or the pointer written by the leader apparatus in the general-purpose data bulletin board) does not match a hash value obtained by tracing the information of the general-purpose data bulletin board. The third party can verify whether such a mismatch exists to detect a fraudulent activity by the trading management server 10 (falsification of the content of trading; for example, data to be contracted is not contracted, or data not to be contracted is contracted).

The processing in steps S50 and S51 illustrated in FIG. 18 can be the same as the processing in steps S21 and S22 illustrated in FIG. 13.

As described above, the electronic trading system according to the second example embodiment includes the plurality of trading management servers 10. The plurality of trading management servers 10 monitors the contract processing executed by one trading management server 10, and data on which a consensus of legitimate contract result is built is written in the trading data bulletin board. As a result, a fraudulent activity (fraudulent operation) by one trading management server 10 can be prevented. More strictly, in a case that over half of the trading management servers 10 normally operate, the correct contract processing can be ensured to be performed.

The pointer to the contract result is recorded in the general-purpose data bulletin board so that even in a case that the content of the trading data management ledger is falsified, the third party including the participant can detect the falsification. In other words, in the second example embodiment, two types of electronic bulletin boards (blockchains) are used to execute the electronic trading. The first electronic bulletin board is a bulletin board apparent by (accessible from) all the participants, and the second electronic bulletin board is a bulletin board apparent by (accessible from) only the trading administrator. In the second example embodiment, these two electronic bulletin boards are used differently depending on the intended use to attain both security of trading and fraud detection.

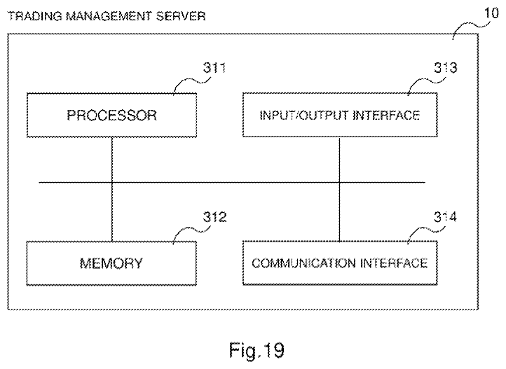

Subsequently, hardware of each apparatus constituting the electronic trading system is described. FIG. 19 is a diagram illustrating an example of a hardware structure of the trading management server 10.

The trading management server 10 can be configured by an information processing apparatus (a so-called computer), and has a structure illustrated in FIG. 19. For example, the trading management server 10 includes a processor 311, a memory 312, an input/output interface 313, a communication interface 314, and the like. The above components such as the processor 311 are configured to be connected to each other via an internal bus or the like to be communicable with each other.

However, the structure illustrated in FIG. 19 is not intended to limit the hardware structure of the trading management server 10. The trading management server 10 may include hardware not illustrated, or may not include the input/output interface 313 as needed. The number of processors 311 or the like included in the trading management server 10 is not intended to limit the example illustrated in FIG. 19, and, for example, a plurality of processors 311 may be included in the trading management server 10.

The processor 311 is, for example, a programmable device such as a Central Processing Unit (CPU), a Micro Processing Unit (MPU), and a Digital Signal Processor (DSP). Alternatively, the processor 311 may be a device such as a Field Programmable Gate Array (FPGA) and an Application Specific Integrated Circuit (ASIC). The processor 311 executes various programs including an Operating System (OS).

The memory 312 is a Random Access Memory (RAM), a Read Only Memory (ROM), a Hard Disk Drive (HDD), a Solid State Drive (SSD), or the like. The memory 312 stores OS programs, application programs, and various pieces of data.

The input/output interface 313 is an interface for a display apparatus or an input apparatus not illustrated. The display apparatus is a liquid crystal display, for example. The input apparatus is an apparatus, for example, receiving a user operation of a keyboard, a mouse, or the like.

The communication interface 314 is a circuit, a module, or the like for communicating with another apparatus. For example, the communication interface 314 includes a Network Interface Card (NIC) or the like.

Functions of the trading management server 10 are implemented by various processing modules. The processing modules are realized by the processor 311 executing the programs stored in the memory 312, for example. The programs can be recorded on a computer-readable storage medium. The storage medium can be a non-transient (non-transitory) storage medium such as a semiconductor memory, a hard disk, a magnetic recording medium, and an optical recording medium. In other words, the present invention can be realized also as a computer program product. The programs can be downloaded via a network, or updated using a storage medium storing the programs. Furthermore, the processing modules described above may be realized by a semiconductor chip.

Note that the participant terminal 20, the management server 40, and the like also can be configured with the information processing apparatus similar to the trading management server 10, and their basic hardware structures are not different from the trading management server 10, and thus, the descriptions thereof are omitted.

### [Example Alteration]

Note that the electronic trading systems, the configurations of the various serves, the operations described in the above example embodiments are illustrative, and not intended to limit the configuration of the system or the like. For example, the leader apparatus may have the function of the follower apparatus. Specifically, the leader apparatus may operate as a part of a server group (a plurality of follower apparatuses) constituting the trading data bulletin board. In this case, the leader apparatus also participates in the consensus building, and thus, the number of follower apparatuses required for the consensus building is fewer by one. For this reason, in a case, for example, that consensuses of “over half” of the follower apparatuses are required, consensuses of “more than half or half” of the follower apparatuses are required. This is because if the contract processing of the leader apparatus is treated as “acceptable”, over half of all of the trading management servers 10 are “acceptable”.

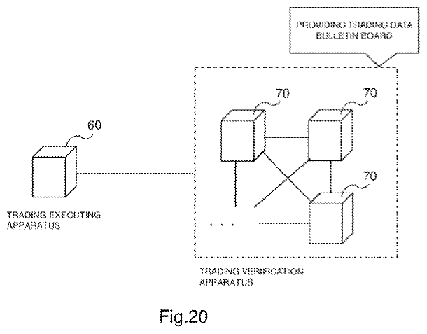

Alternatively, describing the functional aspect of the trading management server 10 according to the second example embodiment, as illustrated in FIG. 20, the leader apparatus operates as a trading executing apparatus 60 and the follower apparatuses operate as trading verification apparatuses 70,

The above example embodiments describe the case that the leader apparatus also includes the ledger for forming the trading data bulletin board, but the leader apparatus may not include the ledger. In other words, the leader apparatus may obtain the data required for performing the contract processing from the trading data bulletin board provided by the plurality of follower apparatuses.

The trading execution function of the leader apparatus or the verification function for the contract result of the follower apparatus may be realized by a smart contract. In other words, the trading execution function or the verification function described above may be implemented in the trading management servers 10 constituting the blockchain by the smart contract.

In a plurality of flowcharts used in the above description, a plurality of steps (processes) are described in order, but the order of performing of the steps performed in each example embodiment is not limited to the described order. In each example embodiment, the illustrated order of the steps may be modified within a scope not affecting the contents, such as performing the processes in parallel, for example.

The whole or part of the example embodiments disclosed above can be described as in the following supplementary notes, but are not limited to the following.

### (Supplementary Note 1)

An electronic trading system including:

a plurality of management servers (40, 101) configured to provide a first electronic bulletin board;

a participant terminal (20, 102) configured to write bid data in the first electronic bulletin board; and

a trading management server (10, 103) configured to acquire the written bid data, and use the acquired bid data to execute trading through Zaraba method,

wherein

the trading management server (10, 103) is configured to generate a public key and a private key,

the participant terminal (20, 102) is configured to use the public key generated by the trading management server (10, 103) to encrypt the bid data, and

the trading management server (10, 103) is configured to use the private key to decrypt the encrypted bid data.

### (Supplementary Note 2)

The electronic trading system according to supplementary note 1, wherein the trading management server (10, 103) is configured to write in the first electronic bulletin board contract data including an identifier (ID) of contracted selling bid data and an identifier (ID) of contracted buying bid data.

### (Supplementary Note 3)

The electronic trading system according to supplementary note 2, wherein the participant terminal (20, 102) is configured to acquire the written contract data and confirm whether a bid made by the participant terminal is contracted.

### (Supplementary Note 4)

The electronic trading system according to any one of supplementary notes 1 to 3, wherein

the plurality of management servers (40, 101) are directly connected to each other, and

each of the plurality of management servers (40, 101) has a data management ledger for managing data received from outside thereof, and is configured to add the received data in the data management ledger each time a data recording request is received from the participant terminal (20, 102) and the trading management server (10, 103).

### (Supplementary Note 5)

The electronic trading system according to any one of supplementary notes 1 to 4, including

a plurality of the trading management servers (10, 103), wherein

one trading management server (10, 103) of the plurality of trading management servers (10, 103) is configured to operate as a leader apparatus, and each of the trading management servers (10, 103) other than the leader apparatus is configured to operate as a follower apparatus,

at least each of the plurality of follower apparatuses is configured to form a second electronic bulletin board for managing un-contracted bid data,

the leader apparatus is configured to use the bid data acquired from the first electronic bulletin board to perform contract processing, and transmit the bid data acquired from the first electronic bulletin board and a contract result to the plurality of follower apparatuses, and

each of the plurality of follower apparatuses is configured to verify a legitimacy of the contract result of the leader apparatus, and reflects, in a case of obtaining a consensus, with other follower apparatuses, that the contract result of the leader apparatus is legitimate, the contract result of the leader apparatus to the second electronic bulletin board.

### (Supplementary Note 6)

The electronic trading system according to supplementary note 5, wherein the leader apparatus is configured to reflect the contract result of the leader apparatus to the first electronic bulletin board in a case that the contract result of the leader apparatus is reflected to the second electronic bulletin board.

### (Supplementary Note 7)

The electronic trading system according to supplementary note 5 or 6, wherein in a case that a certain number or more of follower apparatuses among the plurality of follower apparatuses determine that the contract result of the leader apparatus is legitimate, a consensus that the contract result of the leader apparatus is legitimate is built.

### (Supplementary Note 8)

The electronic trading system according to supplementary note 7, wherein each of the plurality of follower apparatuses is configured to determine that the contract result of the leader apparatus is legitimate in a case that the contract result of the leader apparatus matches a result of the contract processing using the bid data acquired from the leader apparatus and un-contracted bid data stored in the second electronic bulletin board.

### (Supplementary Note 9)

The electronic trading system according to supplementary note 8, wherein each of the plurality of follower apparatuses is configured to transmit a contract result of the follower apparatus itself to other follower apparatuses.

### (Supplementary Note 10)

The electronic trading system according to any one of supplementary notes 5 to 9, wherein the leader apparatus is configured to write, in the first electronic bulletin board, a transaction ID at the time of transmitting the contract result of the leader apparatus to the plurality of follower apparatuses.

### (Supplementary Note 11)

The electronic trading system according to any one of supplementary notes 5 to 10, wherein the leader apparatus is configured to write, in the first electronic bulletin board, a header of a block, to which the contract result of the leader apparatus is reflected, among blocks of a blockchain constituting the second electronic bulletin board, as a pointer to the contract result.

### (Supplementary Note 12)

The electronic trading system according to any one of supplementary notes 5 to 11, wherein at least a verification function for a contract result of the leader apparatus is realized by a smart contract, the plurality of follower apparatuses having the verification function.

### (Supplementary Note 13)

A trading management server (10, 103),

configured to generate a public key and a private key,

connected to a plurality of management servers (40, 101) providing an electronic bulletin board, and a participant terminal (20, 102) using the public key to write bid data encrypted in the electronic bulletin board, and configured to acquire the written bid data to decrypt the encrypted bid data with the private key, and use the bid data to execute trading through Zaraba method.

### (Supplementary Note 14)

An electronic trading method, in an electronic trading system including a plurality of management servers (40, 101) configured to provide an electronic bulletin board, a participant terminal (20, 102) configured to write bid data in the electronic bulletin board, and a trading management server (10, 103) configured to acquire the written bid data, and use the acquired bid data to execute trading through Zaraba method, the electronic trading method including:

generating a public key and a private key;

using the public key generated by the trading management server (10, 103) to encrypt the bid data; and using the private key to decrypt the encrypted bid data.

### (Supplementary Note 15)

A program causing a computer (311), the computer being mounted on a trading management server (10, 103), the trading management server generating a public key and a private key, and being connected to a plurality of management servers (40, 101) providing an electronic bulletin board and to a participant terminal (20, 102) using the public key to write bid data encrypted in the electronic bulletin board, to execute the processes of:

acquiring the written bid data;

decrypting the encrypted bid data with the private key; and

using the bid data to execute trading through Zaraba method.

Each of the configurations of supplementary notes 13 to 15 can be developed into any one of the configurations of supplementary notes 2 to 12 in the same way as in the case of supplementary note 1.

Note that the disclosures of the above cited literatures in the citation list are incorporated by reference. Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

### REFERENCE SIGNS LIST

10, 10-1 to 10-N, 103 Trading Management Server
20, 20-1 to 20-L, 102 Participant Terminal
30 Data Management System
40, 40-1 to 40-M, 101 Management Server
50 Control Apparatus
60 Trading Executing Apparatus
70 Trading Verification Apparatus
201, 301, 401 Communication Control Section
202 Data Management Section
203 Decrypting Section
204 Trading Executing Section
205, 303 Key Generating Section
206, 403 Signature Verifying Section
207, 304, 404 Storage Section
208, 402 Ledger Control Section
209 Provisional Contract Data Verifying Section
302 Bid Data Management Section
311 Processor
312 Memory
313 Input/Output Interface
314 Communication Interface

What is claimed is:

1. An electronic trading system comprising:
a plurality of management servers configured to provide a first electronic bulletin board;
a participant terminal configured to write bid data in the first electronic bulletin board; and
a trading management server configured to acquire the written bid data, and use the acquired bid data to execute trading through Zaraba method,
wherein
the trading management server is configured to generate a public key and a private key,
the participant terminal is configured to use the public key generated by the trading management server to encrypt the bid data, and
the trading management server is configured to use the private key to decrypt the encrypted bid data.

2. The electronic trading system according to claim 1, wherein the trading management server is configured to write in the first electronic bulletin board contract data including an identifier (ID) of contracted selling bid data and an identifier (ID) of contracted buying bid data.

3. The electronic trading system according to claim 2, wherein the participant terminal is configured to acquire the written contract data and confirm whether a bid made by the participant terminal is contracted.

4. The electronic trading system according to claim 1, wherein
the plurality of management servers are directly connected to each other, and
each of the plurality of management servers has a data management ledger for managing data received from outside thereof, and is configured to add the received data in the data management ledger each time a data recording request is received from the participant terminal and the trading management server.

5. The electronic trading system according to claim 1, comprising
a plurality of the trading management servers, wherein
one trading management server of the plurality of trading management servers is configured to operate as a leader apparatus, and each of the trading management servers other than the leader apparatus is configured to operate as a follower apparatus,
at least each of the plurality of follower apparatuses is configured to form a second electronic bulletin board for managing un-contracted bid data,
the leader apparatus is configured to use the bid data acquired from the first electronic bulletin board to perform contract processing, and transmit the bid data acquired from the first electronic bulletin board and a contract result to the plurality of follower apparatuses, and
each of the plurality of follower apparatuses is configured to verify a legitimacy of the contract result of the leader apparatus, and reflects, in a case of obtaining a consensus, with other follower apparatuses, that the contract result of the leader apparatus is legitimate, the contract result of the leader apparatus to the second electronic bulletin board.

6. The electronic trading system according to claim 5, wherein the leader apparatus is configured to reflect the contract result of the leader apparatus to the first electronic bulletin board in a case that the contract result of the leader apparatus is reflected to the second electronic bulletin board.

7. The electronic trading system according to claim 5, wherein in a case that a certain number or more of follower apparatuses among the plurality of follower apparatuses determine that the contract result of the leader apparatus is legitimate, a consensus that the contract result of the leader apparatus is legitimate is built.

8. The electronic trading system according to claim 7, wherein each of the plurality of follower apparatuses is configured to determine that the contract result of the leader apparatus is legitimate in a case that the contract result of the leader apparatus matches a result of the contract processing using the bid data acquired from the leader apparatus and un-contracted bid data stored in the second electronic bulletin board.

9. The electronic trading system according to claim 8, wherein each of the plurality of follower apparatuses is configured to transmit a contract result of the follower apparatus itself to other follower apparatuses.

10. The electronic trading system according to claim 5, wherein the leader apparatus is configured to write, in the first electronic bulletin board, a transaction ID at the time of transmitting the contract result of the leader apparatus to the plurality of follower apparatuses.

11. The electronic trading system according to claim 5, wherein the leader apparatus is configured to write, in the first electronic bulletin board, a header of a block, to which the contract result of the leader apparatus is reflected, among blocks of a blockchain constituting the second electronic bulletin board, as a pointer to the contract result.

12. The electronic trading system according to claim 5, wherein at least a verification function for a contract result of the leader apparatus is realized by a smart contract, the plurality of follower apparatuses having the verification function.

13. A trading management server comprising:
a memory storing instructions; and
one or more processors configured to execute the instructions,
wherein
the one or more processors are configured to generate a public key and a private key,
the one or more processors are connected to a plurality of management servers providing an electronic bulletin board, and a participant terminal using the public key to write bid data encrypted in the electronic bulletin board, and
the one or more processors are configured to acquire the written bid data to decrypt the encrypted bid data with the private key, and use the bid data to execute trading through Zaraba method.

14. An electronic trading method, in an electronic trading system including a plurality of management servers configured to provide an electronic bulletin board, a participant terminal configured to write bid data in the electronic bulletin board, and a trading management server configured to acquire the written bid data, and use the acquired bid data to execute trading through Zaraba method, the electronic trading method comprising:
generating a public key and a private key;
using the public key generated by the trading management server to encrypt the bid data; and
using the private key to decrypt the encrypted bid data.

15. A non-transitory computer readable recording medium storing a program causing one or more processors, the one or more processors computer being mounted on a trading management server, the trading management server generating a public key and a private key, and being connected to a plurality of management servers providing an electronic bulletin board and to a participant terminal using the public key to write bid data encrypted in the electronic bulletin board, to execute the processes of:
acquiring the written bid data;
decrypting the encrypted bid data with the private key; and
using the bid data to execute trading through Zaraba method.

16. The electronic trading system according to claim 1, wherein the Zaraba method is a method for concluding the trading in order of matching of a price and a quantity among selling bids and buying bids.
